(19) United States
(12) Patent Application Publication
(10) Pub. No.: US 2022/0250872 A1
(43) Pub. Date: Aug. 11, 2022

(54) ELECTROMECHANICAL ACTIVATION OF A UNIDIRECTIONAL EMERGENCY STOP DEVICE FOR A LIFT

(71) Applicant: DYNATECH, DYNAMICS & TECHNOLOGY, S.L., Pina de Ebro, Zaragoza (ES)

(72) Inventor: Francisco de Asis MATEO MUR, Pina de Ebro, Zaragoza (ES)

(21) Appl. No.: 17/629,959

(22) PCT Filed: Aug. 29, 2019
(86) PCT No.: PCT/ES2019/070575

§ 371 Date: Jan. 25, 2022

(51) Int. Cl. B66B 5/18

(52) U.S. Cl. CPC B66B 5/18

(57) ABSTRACT

Electromechanical unidirectional emergency stop device for a lift comprising a support plate (13) in which there are electromechanical means of retention and mechanical means that consist of a connecting rod displaced by the activation spring and where said connecting rod is connected with an articulated lever (6) at the end opposite to the activation means, where this articulated lever (6) has an articulated joint (6.1) with respect to which it rotates and that, at its opposite end, has a roller connecting rod (8) which in turn has a grooved roller (9) at its end that runs through a curved channel (10) made in the protective plate where the connecting rod that moves the articulated lever (6) is a compressible connecting rod (5) consisting of two plates connected to each other through a compressible spring (5.1).

### TECHNICAL FIELD OF THE INVENTION

The object of this invention, as stated in the title of the invention, is a electromechanical unidirectional emergency stop device for a lift that acts as an interface between an electronic overspeed detection system and an element that stops the lift cabin in case of an emergency.

This invention is characterised by the special configuration and design of each of the parts of the mechanism to achieve an effective and safe transmission between an electronic device for overspeed detection and an element that stops the cabin while descending.

This invention lies therefore within the field of lifts, and, in particular, safety measures used to stop a lift.

### BACKGROUND OF THE INVENTION

Due to the evolution of the market towards more precise and versatile electronic components, components which have traditionally been mechanical within lifts are being replaced by electronic components. Communication between the new electronic components and existing mechanical components requires novel developments in the market that link both types of components.

The force of mechanical activation by means of a cable and the adhesion of this cable in a throat of the pulley is replaced by the activation of a spring retained by a coil.

The system's new electronic elements for overspeed detection open a contact at the moment they encounter this safety failure. Thus, these solutions are based on an electromechanical element for activating the parachutes. As soon as there is a power cut in the system, the coil is de-energised and a spring applies the activation force for the parachute, bringing the roller to its braking position.

There are several solutions that are known in the state of the art, such as those described in the patents: WO2014075954, EP1749784, CH707833. In none of the preceding patents is the activation of the articulated lever transmitted by a compressible connecting rod that also allows the recovery of the position of the articulated lever when the emergency activation ceases.

In the state of the art is also known the document WO0039016, which discloses an elevator braking system including an accelerometer for detecting acceleration of an elevator car and generating an acceleration signal. An over-acceleration detection module compares the acceleration signal to an acceleration threshold.

Therefore, it is the object of this invention to develop alternative solutions to the unidirectional solutions for braking lifts in emergency situations, where the device comprises a compressible cam such as the one described below and that is included in essence in the first claim.

### DESCRIPTION OF THE INVENTION

The object of this invention is a unidirectional emergency stop device for a lift that is based on the use of means of activation associated with mechanical means that translate the action into the wedging of a roller on a guide.

The means of activation are preferably based on a coil that, upon disconnection, ceases to act, moving a sliding coupler, to which is connected the axis of the coil and a connecting rod which is, in turn, connected to an articulated lever at a midpoint thereof.

The articulated lever has an articulated joint at one of its ends with respect to which it rotates, while at its opposite end it has a roller connecting rod on whose free end a grooved roller is mounted that then runs through a channel made in the cover.

The connecting rod that transmits the action to the articulated lever is a compressible connecting rod equipped with two plates connected by a spring. This compressible connecting rod performs a double function: it allows the transmission of the action towards the articulated lever on the one hand, and on the other hand it also allows the recovery of the initial position of the articulated lever, once the emergency activation ceases.

In addition, the articulated lever has a limit switch designed and positioned so that, when the wedging position is reached by the lever, the lever contacts the trailing roller of a limit switch that indicates that a wedging position has been reached. This configuration allows an accurate detection of this position while simplifying installation tasks, as it is much easier for the operator to install.

Except when stated otherwise, all the technical and scientific elements used in this specification have the meaning usually understood by a person skilled in the art of this invention. In practice, this invention can use processes and materials that are similar or equivalent to those described in the specification.

Throughout the description and claims the term “comprises” and the various forms thereof are not meant to exclude other techniques, additives, components or steps. A person skilled in the art will recognise that other objects, advantages and features of the invention follow in part from the description and in part from the practising of the invention.

### BRIEF DESCRIPTION OF THE DRAWINGS

In order to complement the description being made and to aid towards a better comprehension of the features of the invention, according to our preferred practical embodiment, we incorporate as an integral part of said description a set of drawings that are illustrative and not limiting in nature and represent the following.

FIG. 1 shows a front view of the device that is the object of the invention.

FIG. 2 shows a representation of the device in a top-down perspective.

FIG. 3 shows an isometric view of the device.

FIG. 4 shows another isometric view of the device.

### DETAILED DESCRIPTION OF THE INVENTION

In view of the figures, a preferred embodiment of the proposed invention is described below.

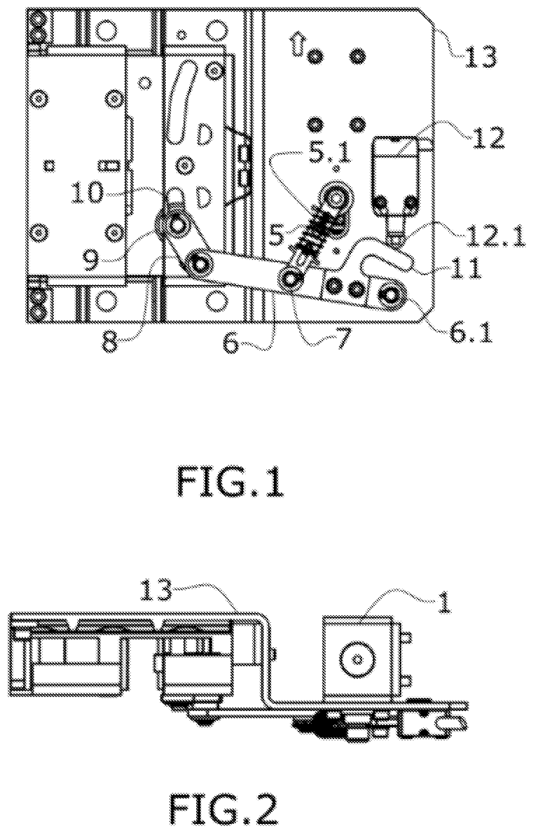

FIG. 1 shows that the unidirectional emergency stop device for a lift comprises a support plate (13), to which are mounted means of activation and mechanical means activated by the means of activation, where said mechanical means consist in a compressible connecting rod (5) displaced by the activation means, and where said compressible rod is connected at its opposite end to the means of activation with an articulated lever (6).

The articulated lever (6) has an articulated joint (6.1) with respect to which it rotates, and at its opposite end it has a roller connecting rod (8) that, in turn, has a grooved roller (9) at its end, which runs along a curved channel (10) made in the protection plate.

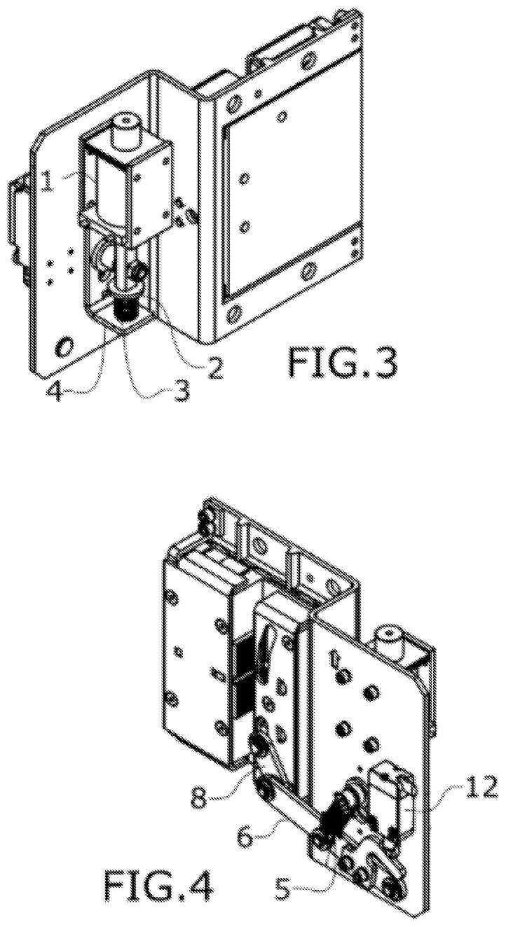

The means of activation are based on the use of a coil (1), as can be seen in FIG. 2, while FIG. 3 shows that on the coil (1) there is an axis, on the end of which there is a moveable coupling (2) that moves against the force of a spring (3) placed between the moveable axis (2) and a support plate (4).

FIGS. 1 and 4 show the compressible connecting rod (5), which consists of two plates joined to one another by a compression spring (5.1). This compressible cam configuration allows on the one hand the transmission of the action to the articulated lever (6) and therefore the wedging of the guide, and on the other hand when the activation of the emergency stop allows the recovery of the original position of the compressible lever (6) towards a non-braking position.

In addition, the articulated lever (6) has a limit switch cam (11) designed and positioned in such a manner that when the articulated lever reaches the wedging position it contacts the trailing roller (12.1) of a limit switch (12).

1. Electromechanical unidirectional emergency stop device for a lift comprising a support plate (13) in which there are activation means (1) and mechanical means activated by the activation means (1) (1), where said mechanical means consist of a connecting rod (5) displaced by the activation means (1) and where said connecting rod (5) is connected with an articulated lever (6) at the end opposite to the activation means(1), where this articulated lever (6) has an articulated joint (6.1) with respect to which it rotates and that, at its opposite end, has a roller connecting rod (8), which, in turn, has a grooved roller (9) at its end that runs through a curved channel (10) made in the protective plate characterised in that the connecting rod (5) that moves the articulated lever (6) is a compressible connecting rod (5) consisting of two plates connected to each other through a compressible spring (5.1).

2. Electromechanical unidirectional emergency stop device for a lift according to claim 1 characterised in that the activation means (1) are based on the use of a coil (1) equipped with an axis at the end of which there is a moveable coupling (2) that moves against the force of a spring (3) placed between the moveable axis (2) and a support plate (4).

3. Electromechanical unidirectional emergency stop device for a lift according to claim 1 or 2, characterised in that the articulated lever (6) has a limit switch cam (11) designed and positioned in such a way that when the articulated lever reaches the wedging position it contacts the trailing roller (12.1) of a limit switch (12).
